(19) United States
(12) Patent Application Publication
(10) Pub. No.: US 2017/0123298 A1
(43) Pub. Date: May 4, 2017

(54) LENS SYSTEM INCLUDING INTERCHANGEABLE ELEMENTS

(71) Applicant: Brass Roots Technologies, LLC, Plano, TX (US)

(72) Inventors: Matthew Glen Hine, Richardson, TX (US); Nathan Wainwright, Melissa, TX (US); John David Jackson, Allen, TX (US)

(21) Appl. No.: 15/285,046

(22) Filed: Oct. 4, 2016

Related U.S. Application Data
(60) Provisional application No. 62/248,503, filed on Oct. 30, 2015.

(51) Int. Cl. G03B 17/56; G02B 7/02; G03B 17/12

(52) U.S. Cl. CPC G03B 17/565; G03B 17/12; G02B 7/02; G02B 5/005

(57) ABSTRACT

An imaging lens system allows for the use of interchangeable lens elements. The interchangeable element may be any type of device that affects the image produced by the imaging lens and is preferably inserted into the lens at a position at or near the aperture stop. The lens housing preferably includes an insertion area which allows for the placement of the interchangeable element.

This application claims priority to U.S. Provisional Patent Application No. 62/248,503, entitled “Lens System Including Interchangeable Elements,” filed on Oct. 30, 2015, the entire contents of which are hereby incorporated by reference.

### BACKGROUND

This disclosure pertains to imaging lenses for cameras, and particularly to interchangeable elements that may be inserted into imaging lenses to produce desired effects.

Traditionally, photographic and video imaging lenses frequently allow the use of special effects filters on the outside of the lens, or in front of the first element, or in rare cases, between the last element and the camera. Lenses for other uses such as machine vision, scientific, or medical imaging may also use filters mounted in a similar way to alter the images captured. Types of filters often used include neutral density filters, polarizers, and color filters. Less common filters include soft-focus filters, diffusers, and star-effect filters.

However, all traditional filters or the use thereof are subject to the same limitation: because the aperture stop of the system is rarely external to the system, the filters affect every point in the image differently. In other words, every point in the field passes through a different part of the filter. Thus the effect on the image is not homogeneous across the field. In some cases, such as when using neutral density filters, this is not a problem because there is little angular sensitivity in the filter's performance or the transmission function is spatially uniform. However, uncommon special effects can also be achieved by modifying the pupil or the wavefront therein. In order to apply such effects to whole image, the filter must be located at the aperture stop, where all the light bundles from the entire image overlap in the system.

### SUMMARY

The present disclosure relates generally to imaging lenses for use in digital or film cameras that allow for the use of interchangeable filters to create special effects or otherwise alter the images the cameras capture, whether still images or video. Unlike traditional filters, the present interchangeable filters are placed at or near the aperture stop, where all chief rays and marginal rays (except for vignetting) overlap momentarily, so that all the fields pass through the same region of the filter. The filter therefore has an equal effect on every point in the image.

Uniformity of filter effects across the field is desirable for existing filters, but importantly, it also opens up new opportunities for effects that are traditionally impossible. One example is an apodization filter that can be used to shape out-of-focus areas of the image. To implement this effect, the pupil function of every point in the field must be altered the same way. The only way to do this is by modifying the ray bundles where they all overlap: at the aperture stop (or thereabouts, depending on the field of view). There are some commercially available lenses that currently implement an apodization filter near their aperture stop. However, these are fixed effects and cannot be removed. In many cases, the user many not want such an effect for some images or may want a different effect entirely while still using the same imaging lens. It is desirable to be able to remove and or replace the special effect filter without switching lenses.

The present interchangeable lens elements have been developed to allow such operation as described above. The present lens system allows the user to insert and remove elements at or near the aperture stop of the provided imaging lens. The imaging lens includes all optical and mechanical provision necessary to allow such operation while maintaining excellent imaging performance in every intended configuration. The unique location of the interchangeable filters in the imaging lens enables particular special effects or image alterations to be achieved in images and video which may not otherwise be possible in standard imaging lenses where filters cannot be located near the aperture stop.

The present imaging lens substantially consists of a front group of lens elements, an aperture stop, and a rear group of lens elements. The front group of one or more lens elements is located forward of the aperture stop toward object space, and the rear group of one or more lens elements is located aft of the aperture stop toward image space. The interchangeable element is removably positioned adjacent to or at the aperture stop. “Removably” means it can be inserted or removed by the user and the remaining optics will still function. “Adjacent to” the aperture stop means close to the aperture stop, preferably with no additional elements between the interchangeable element and the aperture stop, but it does not require the element to be positioned exactly at the aperture stop.

The housing of the imaging lens also includes an insertion area in which optical filters may be inserted at or near the aperture stop. This insertion area may include, but is not limited to, an open slot or hinged door whereby filters can be individually inserted or removed. The lens housing may also include a track which holds a magazine of filters that can translate into position as desired, or a disc which holds a turret of filters that rotate into position as desired. The housing may also be constructed to allow insertion and removal of filters by partial disassembly of the imaging lens. It is understood that the means by which the optical element is inserted into the system may be varied in any appropriate manner by the skilled artisan.

The interchangeable element may be any type of device that affects the image produced by the imaging lens. The elements typically include a transparent dielectric substrate, but more generally may be made of any material that is reflective, transmissive, absorptive, or any combination thereof. The interchangeable element could also be an active device that mechanically moves, electronically transforms, such as a liquid crystal panel, or chemically changes state or optical properties over time. The interchangeable element may be a lens. The lens may have some type of filter applied or imbedded that would accomplish the desired optical effects, such as a switched lens.

It is preferred that the optical design of the system should nominally consider the presence (thickness, index, dispersion, surface shapes, etc.) of the interchangeable element for best performance. However, this is not always necessary. An existing lens design could be retrofitted with such a device and the performance degradation may be acceptable to the user. Or the system could allow adjustment of other lens groups to attempt to compensate for the interchangeable element.

### BRIEF DESCRIPTION OF THE DRAWINGS

FIG. 1 shows a three-dimensional view of a camera having an imaging lens that allows the insertion of an external element.

FIG. 2 shows a cross-sectional view of an example of a lens design having components in accordance with the present design.

### DETAILED DESCRIPTION OF PREFERRED EMBODIMENTS

The present disclosure relates to an imaging lens for a camera that allows for the use of interchangeable lens elements. The interchangeable element may be any type of device that affects the image produced by the imaging lens and is preferably inserted into the lens at a position at or near the aperture stop. The lens housing preferably includes an insertion area that allows for the placement of the interchangeable element.

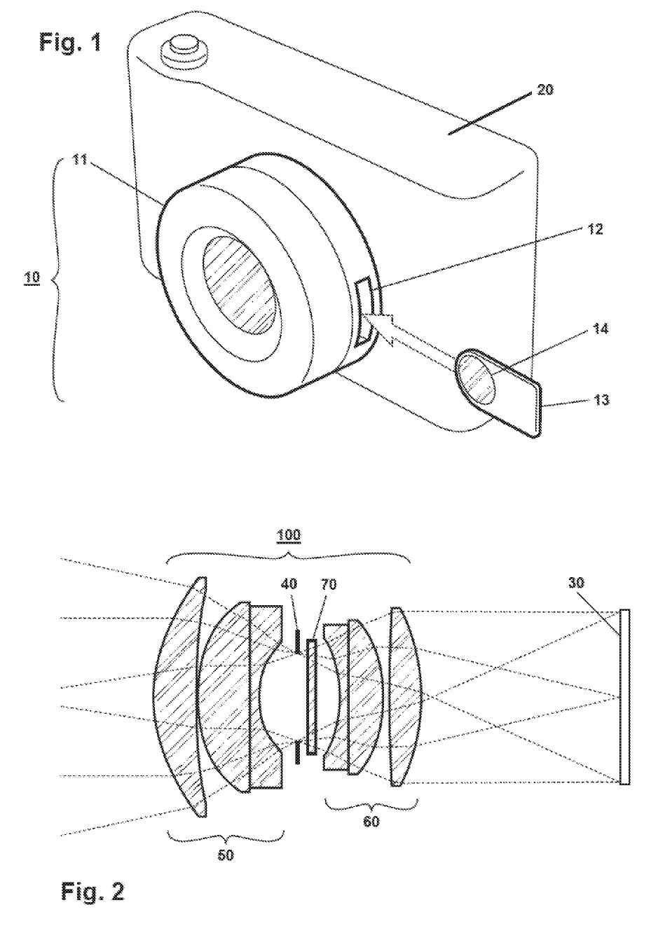

FIG. 1 shows a camera body 20 on which is mounted an example lens system 10 of the present invention. The housing 11 of the lens system has an insertion area 12 to allow the insertion of an interchangeable component 13. As described earlier, the method by which the component is changed may be accomplished in a variety of ways. In certain embodiments, the interchangeable component includes an optical element 14 consisting of, for example, transmissive, absorptive, and/or reflective features.

FIG. 2 shows a cross-sectional diagram of an example photographic objective showing the major components in the system. In this embodiment, an optical system 100 forms images on the sensor 30 or film of a camera. The optical system 100 is composed of an aperture stop 40, one or more forward lens elements 50 forward of the aperture stop (i.e. toward object space), and one or more aft lens elements 60 aft of the aperture stop (i.e. toward image space). In the preferred embodiment, the interchangeable element 70 is nominally located near the aperture stop 40 of the optical system 100. The interchangeable element 70 should be situated as close as possible to the aperture stop 40 for best performance of certain filters. Mechanical space constraints may limit the proximity of the interchangeable element 70 to the aperture stop 40, but the preferred embodiment is that there are no other optical elements between the interchangeable element 70 and the aperture stop 40. In the preferred embodiment shown in FIG. 2, the one or more lens elements 50 forward of the aperture stop and the one or more lens elements 60 aft of the aperture stop include three lens elements, but these may range in number from one to any desired number.

The nature of the interchangeable element may be varied in numerous ways. The interchangeable element may be any type of device that affects the image produced by the imaging lens. Some preferred embodiments of optical devices are as follows:

An apodization filter that alters the transmission function in gradient fashion across the pupil, thus allowing specific shaping of out-of-focus areas of the image.

A wedge prism that refracts all wavefronts at the same angle, thus tilting the plane of focus.

A lens that modifies certain properties or aberrations of the lens system. An example is a lens that adds positive or negative field curvature to the wavefront, in effect changing focus across the image such that the center of the image can be blurred while off-axis fields are blurred, or vice versa. Another example is a lens that alters the longitudinal aberration function in a specific way to affect the out-of-focus areas of the image in a variety of ways, such as creating ring or halo artifacts.

A filter that scatters some amount of light while leaving another amount of light unperturbed, thus creating a soft-focus effect. The filter could be an engineered diffuser or a holographic element.

A filter that operates via diffraction or interference. One example is a diffraction grating that imparts dispersive artifacts to the image. Another example is a hologram that creates predetermined patterns around bright points in the image.

A partially reflective element that increases the magnitude of veiling glare in the image, thus increasing the visibility of lens flare, a common artifact in photographs.

A part that uses its entire thickness to affect the raypaths. An example is a honeycomb structure made of black absorbing membrane to control field of view, such as is used on sniper scopes where the entrance pupil is at the front lens element. Another example is a thick aperture where the exposed sidewalls of interior sections are reflective, thus creating interesting veiling glare and out-of-focus artifacts.

A glass plate on which is deposited a grayscale, color, half-tone, or multi-tone pattern. An example is a reticle on a glass slide that can be used to act as a custom aperture. The purpose of the reticle could also be to shape out-of-focus parts of the image.

A part which is a combination of various other filters or dissimilar materials such as plastic, metal, or fiber. An example consisting of multiple color filters could resemble a stained-glass window. A part that uses fibers or metal wires may be used to create variations of the traditional star filter. The element could include a grid pattern of wires or fibers, or any other pattern of wires or fibers.

An active device which is electronically switchable such as a liquid lens or a liquid crystal display.

A passive device which is mechanically switchable such as a part that could be translated across the aperture during or between exposures.

Generally speaking, any device which can change optical properties via chemical or other physical actions can be used as the interchangeable element. For example, phosphorescent, fluorescent, or luminescent filters could be used.

Other standard filters that are commonly used in photography could also be used as the interchangeable element in the present system and be placed at or near the aperture stop. An advantage would be that the filters used at or near the aperture stop would be much smaller than they need to be when used outside the lens. For example, they might have a 0.5 inch diameter compared to a 2 inch diameter. Thus, the user could carry more filters in a smaller space.

Other elements include a polarizing element, a birefringent element, a neutral density filter, or a bandpass filter such as a UV or IR cut filter.

### EXAMPLES

The following is a description of two filters that were tested in a specially-designed imaging lens that allows for the insertion of a removable element near the aperture stop. The wedge prism was successful in tilting the plane of best focus. When placed in front of the imaging lens, the wedge prism merely biases the field of view slightly in one direction. When placed at the stop, the particular nature of the rear group allows the ray bundles to essentially translate across the Petzval surface in image space. However, the amount of tilt achievable is limited both by thickness of the wedge and by the astigmatism that is introduced by adding prismatic power to the wavefront. The extra aberrations are somewhat mitigated by decreasing the aperture size. It should be noted that increasing the refraction angle by using a higher index glass for the wedge prism is deleterious to performance. The apodization filter, when designed appropriately, successfully created smooth blur on the edges of out-of-focus areas of the image. When used in a location not adjacent-to the aperture stop, such as in front of the imaging lens, the apodization filter merely vignettes the image in a progressive manner.

1. A lens system for capturing an image, comprising:
an image focal point on which the image is captured;
one or more aft lens elements located adjacent to the image focal point;
an aperture stop located adjacent to the one or more aft lens elements, wherein the one or more aft lens elements are located between the aperture stop and the image focal point;
one or more forward lens elements located adjacent to the aperture stop, wherein the aperture stop is located between the one or more forward lens elements and the one or more aft lens elements; and
an interchangeable element removably positioned adjacent to the aperture stop, wherein the interchangeable element is removably positioned between the aperture stop and the one or more aft lens elements or between the aperture stop and the one or more forward lens elements, and wherein the interchangeable element comprises a feature that alters the image captured on the image focal point.

2. The lens system of claim 1, further comprising a housing, wherein the housing comprises an insertion area allowing the interchangeable element to be removably positioned adjacent to the aperture stop.

3. The lens system of claim 1, wherein the image focal point is a sensor or film of a camera.

4. The lens system of claim 1, wherein the interchangeable element is an apodization filter, a wedge prism, a lens, a diffuser, a hologram, a diffractive element, a partially reflective element, a reticle deposited on a transparent substrate, a color filter, a bandpass filter, a neutral density filter, a liquid lens, a liquid crystal device, a phosphorescent filter, a fluorescent filter, a luminescent filter, a polarizing element, a birefringent element, a pattern of wires, a pattern of fibers, or a combination thereof.

5. A camera comprising the lens system of claim 1.

6-11. (canceled)

12. A method for altering an image captured by a camera having an aperture stop, comprising:
placing an interchangeable element adjacent to the aperture stop of the camera; and
capturing an image with the camera, wherein the interchangeable element comprises a feature that alters the image captured by the camera.
